(19) United States
(12) Patent Application Publication
(10) Pub. No.: US 2020/0024186 A1
(43) Pub. Date: Jan. 23, 2020

(54) WINDOW FILM

(71) Applicant: 3M INNOVATIVE PROPERTIES COMPANY, St. Paul, MN (US)

(72) Inventors: Yorinobu Takamatsu, Sagamihara-city (JP); Atsushi Ono, Tokyo (JP)

(21) Appl. No.: 16/517,028

(22) Filed: Jul. 19, 2019

(30) Foreign Application Priority Data
Jul. 20, 2018 (JP) 2018-136749

(51) Int. Cl. C03C 17/32; C08K 5/00; C08K 3/014; C08K 3/22; C08K 3/38; C08K 3/04; C09J 7/25; C09J 7/38; C08K 5/3492

(52) U.S. Cl. CPC C03C 17/324; C08K 5/005; C08K 3/014; C08K 3/22; C08K 3/38; C08K 3/04; C08K 2003/2258; C09J 7/385; C08K 5/3492; C08J 2433/08; C08K 2201/019; C08K 2003/2231; C09J 7/255

(57) ABSTRACT

A window film that can be applied to a window glass with sufficient adhesive strength at a short curing time when using the water bonding method, and can provide an excellent appearance in which aeration of air bubbles and whitening are suppressed is described.

### TECHNICAL FIELD

The present disclosure relates to window films.

### BACKGROUND ART

Window films are adhesive films that are applied to window glasses such as those of vehicles such as automobiles, ships, and railroads, and buildings such as houses, apartments, and office buildings, and are widely used for shielding ultraviolet light and/or infrared light in sunlight, protection of privacy, prevention of criminals, prevention of shattering of glass, decoration, and the like.

One method of applying the window film to the window glass is a water bonding method. The water bonding method includes applying the construction liquid on the window film and/or the surface of the window glass by spraying, applying the window film to the surface of the window glass, optionally positioning the window film, and then pressing and adhering the window film on the window glass while scraping the construction liquid between the window film and the window glass by a squeegee. An aqueous solution containing a surfactant at a low concentration (for example, from 1 mass % to 10 mass %) is commonly used as the construction liquid. By using the water bonding method, the window film can be applied to the window glass with high accuracy and an aesthetically pleasing appearance.

Patent Document 1 (JP 2008-248131 A) describes “an adhesive for sunlight shielding film comprising (A) a (meth)acrylic acid ester copolymer having a carboxyl group as a crosslinkable functional group, (B) a metal chelate-based crosslinking agent, and (C) a triazine-based UV absorber.”

Patent Document 2 (JP 2016-114879 A) describes “a window film having a substrate, and an adhesive layer disposed on the substrate, wherein the adhesive layer contains an acrylic copolymer and a triazine-based UV absorber, the acrylic copolymer containing from 1 to 20 mass % of a methyl acrylate monomer unit based on the solid content of the acrylic copolymer, the adhesive layer containing from 10 to 20 parts by mass of the triazine-based UV absorber based on 100 parts by mass of the acrylic copolymer, wherein the image clarity is from 80 to 100%, as measured by using an image clarity measuring apparatus according to JIS K7374:2007 in which the window film is placed on a sample stage so that the adhesive layer of the window film is faced on a light source at a sample stage angle of 45°, the transmission mode, and the comb width of 0.125 mm.”

Patent Document 3 (JP 2018-047598 A) describes “a window applying film comprising a first substrate film, an intermediate layer, a second substrate film, and an adhesive layer which are laminated in this order, wherein the first substrate film and the second substrate film are connected via the intermediate layer, and a metal layer is provided on a side opposite to a side in which the adhesive layer is laminated with reference to the second substrate film.”

### SUMMARY OF INVENTION

### Technical Problem

After the window film has been applied by the water bonding method, the moisture of the construction liquid remaining between the window film and the window glass is steamed out from the side of the window film and/or through the thickness of the window film, and finally the window film is completely adhered to the window glass. The adhesive force of the window film is temporarily reduced when the construction water is adhered and recovers with a decrease in moisture remaining between the window film and the window glass. Therefore, the adhesive force of the window film immediately after the application is not sufficient, and the window film may be easily peeled off or displaced when an external force is applied to the window film. Therefore, a curing period of about one day is often required after application of the window film.

Additionally, in the water bonding method, when the construction liquid between the window film and the window glass is squeegeed by a squeegee, or when the window film is pressed against the window glass by a squeegee, the window film may be pulled with the squeegee and stress may remain in the window film. In a case where the residual stress of the window film is greater than the surface tension of the construction water present between the window film and the window glass, and the adhesive force of the window film to the window glass has not yet sufficiently recovered, the window film returns to its original shape, there is a risk of floating of the window film, i.e., generation of air bubbles between the window film and the window glass. This is particularly pronounced when deforming and applying the window film to the window glass having a curved surface, such as a front window and a rear window of an automobile.

Furthermore, the adhesive layer of the window film absorbs the moisture of the construction liquid, and the absorbed moisture aggregates in the adhesive layer to form fine water droplets, thereby causing the adhesive layer and the entire window film to appear white (whitening). This whitening eliminates by evaporating the moisture of the construction liquid by sufficiently ensuring the curing period.

However, for automobile window films and the like, it is desirable to enable a large shortening of the curing time, that is, the delivery immediately after application of the window film.

The present disclosure provides a window film that can be applied to a window glass with sufficient adhesive force at a short curing time when using the water bonding method, and can provide an excellent appearance in which aeration of air bubbles and whitening are suppressed.

### Solution to Problem

According to one embodiment of the present disclosure, a window film having a film layer and a pressure sensitive adhesive layer including a (meth)acrylic copolymer, in which an SP value of the (meth)acrylic copolymer is less than 20 (MPa)^{1/2}, is provided.

### Advantageous Effects of Invention

The window film of the present disclosure can be applied to the window glass with sufficient adhesive force at a short curing time when using the water bonding method, and can provide an excellent appearance in which aeration of air bubbles and whitening are suppressed.

It should not be construed that the above descriptions disclose all embodiments of the present invention and all advantages of the present invention.

### BRIEF DESCRIPTION OF DRAWINGS

FIG. 1 is a schematic cross-sectional view of a window film according to an embodiment.

FIG. 2 is a schematic cross-sectional view of a window film according to another embodiment.

FIG. 3 is a schematic cross-sectional view of a window film according to a further embodiment.

### DESCRIPTION OF EMBODIMENTS

Although representative embodiments of the present invention will now be described in more detail for the purpose of illustration with reference to the drawings, the present invention is not limited to these embodiments. The elements having similar reference numerals in different drawings indicate similar or corresponding elements.

In the present disclosure, a “film” embraces articles referred to as a “sheet”.

The term “pressure-sensitive adhesiveness” as used herein means properties of a material or a composition having permanently adhesiveness within a range of the use temperature, for example, within a range of 0° C. or higher and 50° C. or lower, being capable of adhering to various surfaces with a light pressure without changing the phase (from liquid to solid).

In the present disclosure, “ethylenically-unsaturated” means that the compound has a double bond formed between carbon atoms excluding carbon atoms forming the aromatic ring, and “monoethylenically-unsaturated” means having one double bond formed between carbon atoms excluding carbon atoms forming the aromatic ring.

In the present disclosure, “(meth)acrylate” means an acrylate or a methacrylate, and “(meth)acryl” means an acryl or a methacryl.

In the present disclosure, “total light transmittance” is determined in accordance with JIS K 7361-1:1997 (ISO 13468-1:1996).

In the present disclosure, “visible light” is a light having a wavelength from 380 nm to 780 nm, “infrared” is a light having a wavelength from 780 nm to 2,500 nm, and “ultraviolet ray” is a light having a wavelength from 300 nm to 380 nm.

In the present disclosure, “glass” refers to a resin glass containing silicate glass being composed of silica, silicate salt glass, soda-lime glass, quartz glass, chalcogen glass, metallic glass, organic glass, and polycarbonate (PC), polymethyl methacrylate resin (PMMA), and the like.

The window film of one embodiment has a film layer and a pressure-sensitive adhesive layer including a (meth)acrylic copolymer. The solubility parameter (SP value) of the (meth)acrylic copolymer is less than about 20 (MPa)^{1/2}.

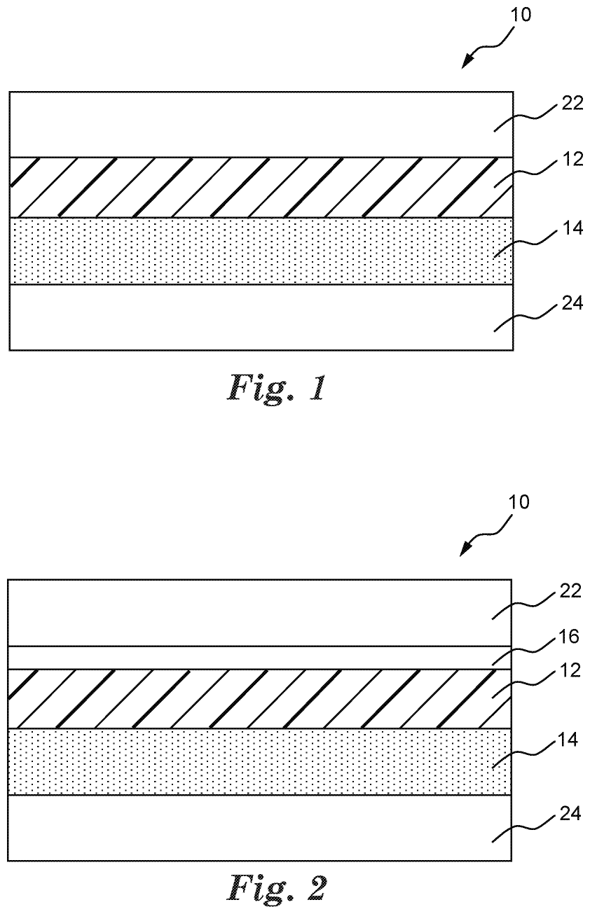

The schematic cross-sectional view of a window film according to an embodiment is illustrated in FIG. 1. A window film 10 has a film layer 12 and a pressure sensitive adhesive layer 14. The window film 10 of FIG. 1 has, as optional components, a surface protective liner 22 over the film layer 12 (top in FIG. 1) and a release liner over (below in FIG. 1) the pressure sensitive adhesive layer 14.

As the film layer 12, films containing polyesters such as polyethylene terephthalate (PET) or polyethylene naphthalate (PEN); polyolefins such as polyethylene (PE), polypropylene (PP), poly 4-methyl-penten-1, or polybuten-1; aclylilc resins such as polyamides (PA), polyimides (PI), cellulose acetate, polyvinyl chloride (PVC), polycarbonate (PC), polyvinyl alcohol (PVA), polyphenylene sulfide, polyethersulfone, polyethylene sulfide, polyphenylene ether, polystyrene, or polymethyl methacrylate (PMMA); or fluorine resins such as polyvinylidene fluoride (PVDF), polytetrafluoroethylene (PTFE), and polyethylene trifluoride (PCTFE), or laminate films thereof can be used. It is advantageous for the film layer 12 to be a polyethylene terephthalate (PET) film in terms of transparency, stability, cost, strength, and thermal processability.

The film layer 12 may be transparent to visible light. In one embodiment, the total light transmittance of visible light in the film layer 12 is about 85% or greater, about 90% or greater, or about 95% or greater.

The film layer 12 may be colored with a pigment or dye. In one embodiment, the total light transmittance of visible light in the film layer is about 85% or less, about 50% or less, or about 30% or less.

The film layer 12 may include additives such as fillers, lubricants, antioxidants, or photostabilizers.

A surface treatment such as corona discharge treatment, plasma treatment, chromate treatment, flame treatment, ozone treatment, or sand blasting may be applied to one side or both sides of the film layer 12 for improving the adhesion to other layers, and a primer layer may be formed.

Although the thickness of the film layer 12 is not particularly limited, the thickness can be, for example, about 10 μm or greater, about 12 μm or greater, about 16 μm or greater, or about 500 μm or less, about 300 μm or less, or about 125 μm or less.

A hard coat layer may be disposed on the opposite side of the film layer 12 from the pressure sensitive adhesive layer 14. The hard coat layer can prevent damage to the surface of the window film due to squeegee or the like. The hard coat layer can be formed by applying a hard coating composition such as urethane, acrylic onto the film layer 12 using a bar coater, a knife coater, a roll coater, a die coater, a gravure coater, or the like, and drying or curing. The thickness of the hard coat layer is generally about 1 μm or greater, or about 2 μm or greater, or about 10 μm or less, or about 5 μm or less.

An anti-smudge coating layer may be disposed on the opposite side of the film layer 12 from the pressure sensitive adhesive layer 14. The anti-smudge coating layer may be formed on the hard coat layer. The anti-smudge coating layer can be formed by coating an anti-smudge coating composition containing a fluororesin, a silicone resin, or the like onto the film layer 12 or the hard coat layer using a bar coater, knife coater, roll coater, die coater, gravure coater, or the like, and drying or curing. The thickness of the anti-smudge coating layer is generally about 0.001 μm or greater, about 0.01 μm or greater, about 10 μm or less, or about 5 μm or less. The anti-smudge coating layer may improve the surface slipperiness of the window film and impart scratch resistance to the window film.

A decorative layer may be disposed on the opposite side of the film layer 12 from the pressure sensitive adhesive layer 14 and/or between the film layer 12 and the pressure sensitive adhesive layer 14. Examples of the decorative layer include metal vapor deposition films such as aluminum, gold, silver, copper, nickel, cobalt, chromium, tin, and indium formed on the film layer 12, and a printed layer formed by inkjet printing, gravure printing, or the like.

The pressure sensitive adhesive layer includes a (meth)acrylic copolymer. The (meth)acrylic copolymer can be obtained by polymerizing or copolymerizing a monomer mixture containing the (meth)acrylic ester monomer. The (meth)acrylic copolymer may be a tacky polymer. The “tacky polymer” refers to a polymer that has a tack at a use temperature (e.g., 5° C., 10° C., 15° C., 20° C., or 25° C.), imparting pressure sensitive adhesiveness to the pressure sensitive adhesive layer. One or more (meth)acrylic ester monomers can be used if desired.

As the (meth)acrylic ester monomer, a (meth)acrylic ester monomer represented by Formula (1):

CH₂═CR′COOR² (1)

can be used. In the formula, R¹ is a hydrogen atom or a methyl group; R² is a straight chain, cyclic, or branched alkyl group having 1 to 20 carbon atoms, a substituted or unsubstituted phenyl group having 6 to 20 carbon atoms, an alkoxyalkyl group having 2 to 20 carbon atoms, a phenoxyalkyl group having 7 to 20 carbon atoms, or a cyclic ether group having 2 to 20 carbon atoms.

Examples of the (meth)acrylic ester monomer represented by Formula (1) include alkyl (meth)acrylates having an alkyl group having 1 to 20 carbon atoms such as methyl (meth)acrylate, ethyl (meth)acrylate, n-butyl (meth)acrylate, isobutyl (meth)acrylate, isoamyl (meth)acrylate, n-hexyl (meth)acrylate, n-octyl (meth)acrylate, isooctyl (meth)acrylate, 2-ethylhexyl (meth)acrylate, isononyl (meth)acrylate, n-decyl (meth)acrylate, isodecyl (meth)acrylate, dodecyl (meth)acrylate, lauryl (meth)acrylate, cyclohexyl (meth)acrylate, 4-t-butylcyclohexyl (meth)acrylate, or isobornyl (meth)acrylate; aromatic (meth)acrylates having a substituted or unsubstituted phenyl group having from 6 to 20 carbon atoms such as phenyl (meth)acrylate or p-tolyl (meth)acrylate; alkoxyalkyl (meth)acrylates having an alkoxyalkyl group having from 2 to 20 carbon atoms such as methoxypropyl (meth)acrylate, or 2-methoxybutyl (meth)acrylate; phenoxyalkyl (meth)acrylates having a phenoxyalkyl group having from 7 to 20 carbon atoms such as phenoxyethyl (meth)acrylate; cyclic ether group-containing (meth)acrylates having from 2 to 20 carbon atoms such as glycidyl (meth)acrylate or tetrahydrofurfuryl (meth)acrylate.

It is advantageous for the (meth)acrylic ester monomer represented by Formula (1) to include alkyl (meth)acrylates having an alkyl group having 6 or more carbon atoms, 7 or more carbon atoms, or 8 or more carbon atoms, or 20 or less carbon atoms, 16 or less carbon atoms, or 12 or less carbon atoms. By using the alkyl (meth)acrylate having an alkyl group having carbon atom numbers described above, sufficient adhesive force can be imparted to the pressure sensitive adhesive layer, and the SP value of the (meth)acrylic copolymer can be easily adjusted to less than about 20 (MPa)^{1/2}.

The alkyl group of the alkyl (meth)acrylate is advantageously straight or branched. The alkyl (meth)acrylate in which the alkyl group is straight or branched can impart sufficient adhesive force to the pressure sensitive adhesive layer.

Suitable alkyl (meth)acrylates include n-hexyl (meth)acrylate, n-octyl (meth)acrylate, isooctyl (meth)acrylate, 2-ethylhexyl (meth)acrylate, isononyl (meth)acrylate, n-decyl (meth)acrylate, isodecyl (meth)acrylate, dodecyl (meth)acrylate, and lauryl (meth)acrylate. Among them, n-octyl (meth)acrylate, isooctyl (meth)acrylate, 2-ethylhexyl (meth)acrylate, isononyl (meth)acrylate, n-decyl (meth)acrylate, and isodecyl (meth)acrylate can be advantageously used. In one embodiment, the alkyl (meth)acrylate includes 2-ethylhexyl (meth)acrylate.

The monomer mixture may comprise a monoethylenically-unsaturated monomer other than the (meth)acrylic ester monomer represented by Formula (1). As the monoethylenically-unsaturated monomer, unsaturated monocarboxylic acids such as (meth)acrylic acids and chrotonic acid; unsaturated dicarboxylic acids such as itaconic acid, fumaric acid, citraconic acid, and maleic acid; and carboxyl-group containing ethylenically-unsaturated monomer such as ω-carboxypolycaprolactone monoacrylate, phthalic acid monohydroxyethyl (meth)acrylate, β-carboxyethyl acrylate, 2-(meth)acryloyloxyethyl succinic acid, and 2-(meth)acryloyloxyethyl hexahydrophthalic acid may be used. By using the carboxyl-group containing ethylenically-unsaturated monomer, it is possible to increase the cohesive strength and adhesive force of the adhesive layer. One or more carboxyl-group containing ethylenically-unsaturated monomers can be used as desired. The (meth)acrylic acid can be advantageously used as the carboxyl-group containing ethylenically-unsaturated monomer from the perspective of improving cohesive strength and adhesive force, polymerization reactivity, cost, and the like.

As monoethylenically-unsaturated monomer, amino-group containing ethylenically-unsaturated monomers such as acrylamide, N,N-dimethyl(meth)acrylamide, N,N-diethyl(meth)acrylamide, N,N-dimethylaminoethyl(meth)acrylate, N,N-diethylaminoethyl(meth)acrylate, N-vinyl pyrrolidone, N-vinylcaprolactam, and (meth)acryloyl morpholine; and nitrogen-containing ethylenically-unsaturated monomers such as acrylonitrile and methacrylonitrile may be used. By using the nitrogen-containing ethylenically-unsaturated monomer, it is possible to increase the cohesive strength and adhesive force of the adhesive layer. One or more nitrogen-containing ethylenically-unsaturated monomers can be used as desired. From the perspective of improving cohesive strength and adhesive force, as the nitrogen-containing ethylenically-unsaturated monomer, (meth)acrylamide, N,N-dimethyl(meth)acrylamide, N-vinylpyrrolidone, N-vinylcaprolactam, and (meth)acryloyl morpholine can be advantageously used. From the perspective of polymerizability and safety, N,N-dimethyl (meth)acrylamide, N-vinylpyrrolidone, N-vinylcaprolactam, and (meth)acryloyl morpholine can be suitably used.

A hydroxyl-group containing ethylenically-unsaturated monomer having a hydroxyalkyl group having from 1 to 20 carbon atoms may be used as the monoethylenically-unsaturated monomer. By using the hydroxyl-group containing ethylenically-unsaturated monomer, it is possible to increase the cohesive strength and adhesive force of the adhesive layer. One or more hydroxyl group-containing ethylenically-unsaturated monomers can be used if desired. From the perspective of improving cohesive strength and adhesive force, cost, safety, and the like, 2-hydroxyethyl (meth)acrylate, 2-hydroxypropyl (meth)acrylate, and 4-hydroxybutyl (meth)acrylate can be advantageously used as the hydroxyl-group containing ethylenically-unsaturated monomer.

As monoethylenically-unsaturated monomers, aromatic vinyl monomers such as styrene, α-methylstyrene, and vinyl toluene; or vinyl esters such as vinyl acetate may also be used. One or more aromatic vinyl monomers and/or vinyl esters can be used as desired.

The (meth)acrylic copolymer can be obtained by copolymerizing a monomer mixture containing about 80 parts by mass or greater, about 85 parts by mass or greater, or about 90 parts by mass or greater, but about 99.5 parts by mass or less, about 99 parts by mass or less, or about 98 parts by mass or less of (meth)acrylic ester monomer of Formula (1), and about 0.5 parts by mass or greater, about 1 part by mass or greater, or about 2 parts by mass or greater, but about 20 parts by mass or less, about 15 parts by mass or less, or about 10 parts by mass or less of another monoethylenically-unsaturated monomer.

The (meth)acrylic copolymer may be crosslinked by copolymerization with a crosslinking monomer. The shear adhesive force of the pressure sensitive adhesive layer can be increased by crosslinking. As crosslinking monomers, multifunctional acrylates, such as 1,6-hexanediol di(meth)acrylate, 1,12-dodecanediol di(meth)acrylate, trimethylolpropane tri(meth)acrylate, pentaerythritol tetra(meth)acrylate, and 1,2-ethylene glycol di(meth)acrylate can be used. One or more crosslinking monomers can be used as desired.

The crosslinking monomer is generally used in an amount of about 0.05 parts by mass or greater, about 0.1 parts by mass or greater, or about 0.2 parts by mass or greater, but about 1 part by mass or less, about 0.8 parts by mass or less, or about 0.5 parts by mass or less, based on a total of 100 parts by mass of the (meth)acrylic ester monomer of Formula (1) and other monoethylenically-unsaturated monomers.

The (meth)acrylic copolymer can be obtained by polymerizing the mixture of the monomers via radical polymerization, for example, solution polymerization, emulsion polymerization, suspension polymerization, or bulk polymerization. Radical polymerization may be thermal polymerization or photopolymerization using a thermal polymerization initiator or a photopolymerization initiator. As thermal polymerization initiators, organic peroxides such as benzoyl peroxide, lauroyl peroxide, and bis(4-tert-butylcyclohexyl) peroxydicarbonate; azo type polymerization initiators such as 2,2′-azobisisobutyronitrile, 2,2′-azobis(2-methylbutyronitrile), dimethyl-2,2-azobis(2-methyl propionate), 4,4′-azobis-(4-cyanovaleric acid), 2,2′-azobis (2-methylpropionic acid) dimethyl, and 2,2′-azobis(2,4-dimethylvaleronitrile) (AVN) can be used. Examples of the photopolymerization initiators include substituted benzoin ethers such as benzoin methyl ether and benzoin isopropyl ether; substituted acetophenones such as 2,2-diethoxyacetophenone and 2,2-dimethoxy-2-phenylacetophenone; substituted α-ketols such as 2-methyl-2-hydroxypropiophenone; aromatic sulfonyl chlorides such as 2-naphthalene sulfonyl chloride; and optically active oximes such as 1-phenyl-1,2-propanedion-2-(ethoxycarbonyl)oxime. The thermal polymerization initiator and the photopolymerization initiator are generally used in an amount of about 0.01 parts by mass or greater, or about 0.05 parts by mass or greater, but about 5 parts by mass or less, or about 3 parts by mass or less based on 100 parts by mass of the monomer mixture.

In one embodiment, the (meth)acrylic copolymer contains about 80 parts by mass or greater, about 85 parts by mass or more, or about 90 parts by mass or greater, but about 99.5 parts by mass or less, about 99 parts by mass or less, or about 98 parts by mass or less of the unit derived from the (meth)acryl ester monomer of Formula (1) based on 100 parts by mass of the (meth)acrylic copolymer.

In one embodiment, the (meth)acrylic copolymer has about 40 parts by mass or greater, about 60 parts by mass or greater, or about 75 parts by mass or greater, but about 99.5 parts by mass or less, about 99 parts by mass or less, or about 98 parts by mass or less of the unit derived from the alkyl(meth)acrylate having an alkyl group having 8 to 12 carbon atoms based on 100 parts by mass of (meth)acrylic copolymer. By setting the content of the unit derived from the alkyl (meth)acrylate having an alkyl group having 6 to 20 carbon atoms, preferably 8 to 12 carbon atoms within the range described above, sufficient adhesive force can be imparted to the pressure sensitive adhesive layer, and the SP values of the (meth)acrylic copolymer can be easily adjusted to less than about 20 (MPa)^{1/2}.

In one embodiment, the (meth)acrylic copolymer has about 0.1 part by mass or greater, about 0.5 parts by mass or greater, or about 1 parts by mass or greater, but about 10 parts by mass or less, about 5 parts by mass or less, or about 3 parts by mass or less of the unit derived from the carboxyl group-containing ethylenically-unsaturated monomer based on 100 parts by mass of the (meth)acrylic copolymer. By setting the content of the unit derived from the carboxyl group-containing ethylenically-unsaturated monomer within the range described above, it is possible to increase the cohesive strength and the adhesive force of the (meth)acrylic copolymer.

In another embodiment, the (meth)acrylic copolymer does not include a unit derived from the carboxyl-group containing ethylenically-unsaturated monomer. In this embodiment, when metal impurities having high affinity with a carboxyl group, in particular an active species such as a divalent iron ion, is included in the window glass which is to be adhered, the metal impurities are less likely to be incorporated into the pressure sensitive adhesive layer. As a result, the degradation of the pressure sensitive adhesive layer due to metal impurities can be prevented, and when the pressure sensitive adhesive layer includes the UV absorber, the consumption of the UV absorber can be reduced.

In one embodiment, the (meth)acrylic copolymer includes the unit derived from the nitrogen-containing ethylenically-unsaturated monomer. When the (meth)acrylic copolymer includes the unit derived from the nitrogen-containing ethylenically-unsaturated monomer, it is possible to increase the cohesive strength and adhesive force of the (meth)acrylic copolymer. In this embodiment, the (meth)acrylic copolymer may contain about 1 part by mass or greater, about 2 parts by mass or greater, or about 5 parts by mass or greater, but about 30 parts by mass or less, about 25 parts by mass or less, or about 20 parts by mass or less of the unit derived from the nitrogen-containing ethylenically-unsaturated monomer based on 100 parts by mass of the (meth)acrylic copolymer.

In one embodiment, the (meth)acrylic copolymer includes the unit derived from the nitrogen-containing ethylenically-unsaturated monomer and the unit derived from the carboxyl-group containing ethylenically-unsaturated monomer. When the (meth)acrylic copolymer includes a combination of the unit derived from the nitrogen-containing ethylenically-unsaturated monomer and the unit derived from the carboxyl group-containing ethylenically-unsaturated monomer, the cohesive strength of the pressure sensitive adhesive layer can be further increased. In addition, in this embodiment, the interaction between the nitrogen-containing group and the carboxyl group decreases the interaction between the carboxyl group and the metal impurities, which makes it possible to suppress the degradation of the pressure sensitive adhesive layer due to the metal impurities described above. In addition, when the pressure sensitive adhesive layer contains the UV absorber, the consumption of the UV absorber can be reduced. In this embodiment, the (meth)acrylic copolymer may contain the unit derived from the nitrogen-containing ethylenically-unsaturated monomer and the unit derived from the hydroxyl group-containing ethylenically-unsaturated monomer in a total amount of about 1 parts by mass or greater, about 2 parts by mass or greater, or about 5 parts by mass or greater, but about 35 parts by mass or less, about 30 parts by mass or less, or about 25 parts by mass or less based on 100 parts by mass of the (meth)acrylic copolymer.

In one embodiment, the (meth)acrylic copolymer includes a unit derived from the nitrogen-containing ethylenically-unsaturated monomer and a unit derived from the hydroxyl-group containing ethylenically-unsaturated monomer. When the (meth)acrylic coplymer includes a combination of the unit derived from the nitrogen-containing ethylenically-unsaturated monomer and the unit derived from the hydroxyl group-containing ethylenically-unsaturated monomer, the cohesive strength and adhesive force of the pressure sensitive adhesive layer can be increased. In addition, in this embodiment, the degradation of the pressure sensitive adhesive layer due to the metal impurities described above can be prevented due to the presence of carboxyl groups. In addition, when the pressure sensitive adhesive layer contains the UV absorber, the consumption of the UV absorber can be prevented. In this embodiment, the (meth)acrylic copolymer may include the unit derived from the nitrogen-containing ethylenically-unsaturated monomer and the unit derived from the hydroxyl-group containing ethylenically-unsaturated monomer in a total amount of about 1 parts by mass or more, about 2 parts by mass or greater, or about 5 parts by mass or greater, but about 35 parts by mass or less, about 30 parts by mass or less, or about 25 parts by mass or less based on 100 parts by mass of the (meth)acrylic copolymer.

In some embodiments, the weight average molecular weight of the (meth)acrylic copolymer is about 100 thousand or greater, about 200 thousand or greater, or about 300 thousand or greater, but about 3 million or less, about 2 million or less, or about 1.5 million or less. In the present disclosure, “weight average molecular weight” refers to a molecular weight converted using GPC standard polystyrene.

In some embodiments, the glass transition temperature (Tg) of the (meth)acrylic copolymer is about −100° C. or higher, about −90° C. or higher, or about −80° C. or higher, but about 30° C. or lower, about 20° C. or lower, or about 10° C. or lower. When the Tg is within the range described above, sufficient cohesive strength and adhesive force can be imparted to the pressure sensitive adhesive layer.

The glass transition temperature Tg (° C.) of the (meth)acrylic copolymer can be calculated by the following formula of FOX as each polymer is copolymerized from n types of monomers:

$$\frac{1}{Tg + 273.15} = {\sum }_{i = 1}^{n} ( \frac{{X}_{i}}{{Tg}_{i} + 273.15} ) \qquad [ Mathematical Formula 1 ]$$

where Tgᵢ is the glass transition temperature (° C.) of the homopolymer of component i, Xᵢ denotes the mass fraction of the monomer of component i added during polymerization, and i is a natural number of 1 to n;

$${\sum }_{i = 1}^{n} {X}_{i} = 1 \qquad [ Mathematical Formula 2 ]$$

The (meth)acrylic copolymer may be crosslinked by a crosslinking agent. Crosslinking using the crosslinking agent can be performed by heating or irradiating the pressure-sensitive adhesive composition containing the (meth)acrylic copolymer and the crosslinking agent. The cohesive strength of the pressure sensitive adhesive layer can be more effectively increased by crosslinking.

When the (meth)acrylic copolymer has a reactive group such as a hydroxyl group, a carboxyl group, and an amino group having active hydrogen, as the thermal crosslinking agent, for example, epoxy crosslinking agents such as N,N,N′,N′-tetra-1,3-benzene di(methanamine) (TETRAD-X, Mitsubishi Gas Chemical Co., Ltd., Chiyoda-ku, Tokyo, Japan), and E-AX, E-5XM (Soken Chemical & Engineering Co., Ltd., Toshima-ku, Tokyo, Japan), N,N′-(cyclohexane-1,3-diylbismethylene) bis(diglycidylamine) (TETRAD-C, Mitsubishi Gas Chemical Company, Chiyoda-ku, Tokyo, Japan), and E-5C (Soken Chemical & Engineering Co., Ltd., Toshima-ku, Tokyo, Japan); bisamide crosslinking agents such as 1,1′-(1,3-phenylenedicarbonyl)-bis(2-methylaziridine), (1,1′-isophthaloyl-bis (2-methylaziridine)), 1,4-bis(ethyleneiminocarbonylamino)benzene, 4,4′-bis(ethyleniminocarbonylamino)diphenylmethane, and 1,8-bis(ethyleniminocarbonylamino)octane; isocyanate crosslinking agents such as tolylene diisocyanate (TDI), hexamethylene diisocyanate (HMDI), isophorone diisocyanate (IPDI), xylylene diisocyanate (XDI), hydrogenated tolylene diisocyanate, diphenylmethane diisocyanate, trimethylolpropane-modified TDI, biurets thereof, isocyanurates thereof, and adducts thereof can be used. One or more thermal crosslinking agents can be used as desired.

The content of the thermal crosslinking agent may be set to be about 0.01 parts by mass or greater, about 0.02 parts by mass or greater, or about 0.05 parts by mass or greater, but about 0.5 parts by mass or less, about 0.4 parts by mass or less, or about 0.3 parts by mass or less based on 100 parts by mass of the (meth)acrylic copolymer.

As the UV crosslinking agent, (meth)acrylic copolymers having a hydrogen radical abstraction structure selected from the group consisting of a benzophenone structure, a benzyl structure, a o-benzoyl benzoate ester structure, a thioxanthone structure, 3-ketocoumarin structure, 2-ethyl anthraquinone structure, and camphorquinone structure can be used. One or more UV crosslinking agents can be used as desired.

The content of the UV crosslinking agent may be set to be about 0.1 parts by mass or greater, about 0.5 parts by mass or greater, or about 1 parts by mass or greater, but about 20 parts by mass or less, about 10 parts by mass or less, or about 5 parts by mass or less based on 100 parts by mass of the (meth)acrylic copolymer.

The solubility parameter (SP value) of the (meth)acrylic copolymer is less than 20 (MPa)^{1/2}. The SP value of the (meth)acrylic copolymer is calculated by using Fedors' method (R. F. Fedors, “A Method for Estimating Both the Solubility Parameters and Molar Volumes of Liquids”, Polym. Eng. Sci., 14(2), pp. 147-154, 1974). The SP value (δ) (in units (MPa)^{1/2}) is defined as the square root of the cohesive energy density as shown below: Where V is molecular weight, ΔEv is cohesive energy (evaporation energy).

SP value (δ)=(ΔEv/V)^{1/2}

Since the pressure sensitive adhesive layer containing the (meth)acrylic copolymer having a SP value of less than 20 (MPa)^{1/2} has low affinity with the construction water, it is possible to easily discharge the construction water from between the pressure sensitive adhesive layer and the window glass. As a result, the adhesive force of the pressure sensitive adhesive layer temporarily reduced due to the presence of the construction water on the surface can be quickly restored, and sufficient adhesive force can be achieved to prevent floating and shifting of the window film in a short cuirng time, for example, about 5 minutes, for example, the adhesive force which is about 20% or greater or about 30% or greater of the maximum adhesive force. This is advantageous in functional window films having other layers such as the hard coat layer and the infrared reflective layer, where moisture is less likely to evaporate through the thickness of the window film. The low affinity of the pressure sensitive adhesive layer with the construction water also contributes to reducing the moisture absorbed by the pressure sensitive adhesive layer and preventing cloudiness of the window film.

In some embodiments, the SP value of the (meth)acrylic copolymer is about 18.5 (MPa)^{1/2} or greater, about 18.8 (MPa)^{1/2} or greater, or about 19 (MPa)^{1/2} or greater and about 19.95 (MPa)^{1/2} or less, about 19.9 (MPa)^{1/2} or less, or about 19.8 (MPa)^{1/2} or less.

The pressure sensitive adhesive layer 14 may include the UV absorber. When the pressure sensitive adhesive layer 14 includes the UV absorber, the window film can be provided with ultraviolet light shielding capability. In addition, when the window film is applied to the inside (indoor side) of the window glass of an automobile, building, or the like, sunlight is first incident on the pressure sensitive adhesive layer 14 and the ultraviolet ray is absorbed, so that it is possible to protect the film layer 12, the optional hard coat layer, the anti-smudge coating layer, the decorative layer, and the like from ultraviolet light and to prevent the degradation.

Examples of the UV absorber include triazine-based UV absorbers including mono(hydroxyphenyl)triazine compounds such as 2-[4-[(2-hydroxy-3-dodecyloxypropyl)oxy]-2-hydroxyphenyl]-4,6-bis(2,4-dimethylphenyl)-1,3,5-triazine, 2-[4-[(2-hydroxy-3-tridecyloxypropyl)oxy]-2-hydroxyphenyl]-4,6-bis(2,4-dimethylphenyl)-1,3,5-triazine, and 2-(2,4-dihydroxyphenyl)-4,6-bis(2,4-dimethylphenyl)-1,3,5-triazine; bis(hydroxyphenyl)triazine compounds such as 2,4-bis(2-hydroxy-4-propyloxyphenyl)-6-(2,4-dimethylphenyl)-1,3,5-triazine, 2,4-bis(2-hydroxy-3-methyl-4-propyloxyphenyl)-6-(4-methylphenyl)-1,3,5-triazine, and 2,4-bis(2-hydroxy-3-methyl-4-hexyloxyphenyl)-6-(2,4-dimethylphenyl)-1,3,5-triazine; and tris(hydroxyphenyl)triazine compounds such as 2,4-bis(2-hydroxy-4-butoxyphenyl)-6-(2,4-dibutoxyphenyl)-1,3,5-triazine, 2,4,6-tris(2-hydroxy-4-octyloxyphenyl)-1,3,5-triazine, and 2,4,6-tris[2-hydroxy-4-(3-butoxy-2-hydroxypropyloxy)phenyl]-1,3,5-triazine; benzophenone-based UV absorbers such as 2,4-dihydroxybenzophenone, 2-hydroxy-4-methoxybenzophenone, 2-hydroxy-4-dodecyloxybenzophenone, 2-hydroxy-4-methoxybenzophenone, 2,2′-dihydroxy-4-metoxybenzophenone, 2,2′-dihydroxy-4,4′-dimetoxybenzophenone, 2-hydroxy-4-metoxy-5-sulfonebenzophenone, bis(2-metoxy-4-hydroxy-5-benzoylphenylmethane), 2,2′,4,4′-tetrahydroxybenzophenone; salicylic acid-based UV absorbers such as phenyl salicylate, p-t-butylphenyl salicylate, and p-octylphenyl salicylate; cyanoacrylate-based UV absorbers such as 2-ethylhexyl 2-cyano-3,3-diphenyl acrylate, ethyl 2-cyano-3,3-diphenyl acrylate, octyl 2-cyano-3,3-diphenyl acrylate; and benzotriazole-based UV absorbers such as 2-(2′-hydroxy-5′-methylphenyl)benzotriazole, 2-(2′-hydroxy-5′-t-butylphenyl)benzotriazole, 2-(2′-hydroxy-3′,5′-di-t-butylphenyl)benzotriazole, 2-(2′-hydroxy-3′-isobutyl-5′-methylphenyl)-5-chlorobenzotriazole, 2-(2′-hydroxy-3′-isobutyl-5′-propylphenyl)-5-chlorobenzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′-t-amyl-5′-isobutylphenyl)-5-chlorobenzotriazole, 2-(2′-hydroxy-3′,5′-di-t-aminophenyl)benzotriazole, 2-{2′-hydroxy-3′-(3″,4″,5″,6″-tetrahydrophthalimidemethyl)-5′-methylphenyl}benzotriazole, and 2,2-methylene bis{4-(1,1,3,3-tetramethylbutyl)-6-(2H-benzotriazole-2-yl)phenol. One or more UV absorbers can be used as desired.

In one embodiment, the UV absorber includes a triazine-based UV absorber. The triazine-based UV absorber has good miscibility with the (meth)acrylic copolymer, but the compatibility with water is relatively low. Therefore, the discharge of the construction water from between the pressure sensitive adhesive layer and the surface of the window glass is promoted by making the pressure sensitive adhesive layer more hydrophobic, and it is possible to effectively utilize the UV absorber by reducing the loss of the UV absorber due to the elution of the UV absorber into the construction liquid. The triazine-based UV absorber can effectively shield the relatively long wavelength ultraviolet light UVA having a wavelength of 320 nm to 400 nm. It is known that UVA does not cause human tanning but penetrates deep into the skin to promote tissue aging. Examples of trade names for triazine-based UV absorbers include Tinuvin (trade name) 400, Tinuvin (trade name) 405, Tinuvin (trade name) 460, Tinuvin (trade name) 477, and Tinuvin (trade name) 479 (all from BASF, Ludwigshafen am Rhein, Land Rheinland-Pfalz, Germany).

The content of the UV absorber may be set to be about 0.1 parts by mass or greater, about 0.5 parts by mass or greater, or about 1 parts by mass or greater, but about 30 parts by mass or less, about 20 parts by mass or less, or about 15 parts by mass or less based on 100 parts by mass of the (meth)acrylic copolymer.

The film layer 12, the hard coat layer, the anti-smudge coating layer, and/or the decorative layer may include the UV absorber described above. In this embodiment, the pressure sensitive adhesive layer may or may not include a UV absorber.

The pressure sensitive adhesive layer 14 may include additives such as fillers, plasticizers, tackifiers, antioxidants, colorants, or antistatic agents. One type or two or more types of additives can be used. The content of the additive is not particularly limited as long as the pressure sensitive adhesiveness is not impaired. The content can be, for example, about 0.1 parts by mass or greater, about 1 parts by mass or greater, or about 5 parts by mass or greater, but about 50 parts by mass or less, about 30 parts by mass or less, or about 20 parts by mass or less based on 100 parts by mass of the pressure sensitive adhesive layer.

The pressure sensitive adhesive layer 14 can be formed by applying the pressure sensitive adhesive composition in which the (meth)acrylic copolymer and optionally the crosslinking agent, the UV absorber, and the additive are dissolved or dispersed in a solvent if needed onto the film layer 12 or another layer using a bar coater, knife coater, roll coater, die coater, gravure coater, or the like, and optionally heating and/or irradiating with a radiation. The pressure sensitive adhesive composition is applied onto the release liner 24 or another liner and, optionally, heated and/or irradiated to form the pressure sensitive adhesive layer 14, and the pressure sensitive adhesive layer 14 may be transferred on the film layer 12 or another layer. As the solvent contained in the pressure sensitive adhesive composition, aliphatic hydrocarbons such as hexane, heptane, and cyclohexane; aromatic hydrocarbons such as toluene and xylene; halogenated hydrocarbons such as methylene chloride and ethylene chloride; alcohols such as methanol, ethanol, propanol, and butanol; ketones such as acetone, methyl ethyl ketone, 2-pentanone, and isophorone; esters such as ethyl acetate and butyl acetate; and cellosolve solvents such as ethyl cellosolve, and the like can be used.

Although the thickness of the pressure-sensitive adhesive layer 14 is not particularly limited, the thickness can be, for example, about 1 μm or greater, about 5 μm or greater, about 10 μm or greater, but about 200 μm or less, about 150 μm or less, or about 100 μm or less. In one embodiment, the window film further includes an infrared absorption layer including an infrared absorber. The schematic cross-sectional view of the window film according to this embodiment is illustrated in FIG. 2. In the window film 10 in FIG. 2, the infrared absorbing layer 16 is disposed on the surface of the film layer 12 opposite to the pressure sensitive adhesive layer 14 as a separate layer. The infrared absorbing layer 16 may be disposed between the film layer 12 and the pressure sensitive adhesive layer 14, or may be disposed on another layer above the film layer 12, such as the hard coat layer, the anti-smudge coating layer, or the decorative layer.

The film layer 12, the hard coat layer, the anti-smudge coating layer, and/or the design layer may be the infrared absorbing layer 16. These layers may include the infrared absorber. In one embodiment, the film layer includes the infrared absorber.

The infrared absorber is a material that has a high transmission of visible light and a large absorptance for infrared light. When the window film has the infrared absorption layer containing the infrared absorber, the energy of infrared light contained in sunlight can be blocked, and temperature increases can be suppressed while a brightness within the vehicle or within the room is maintained. Inorganic infrared absorbers or organic infrared absorbers can be used as the infrared absorber. Inorganic infrared absorbers can be advantageously used in terms of light resistance and weather resistance. One or two or more infrared absorbers can be used if desired. Organic infrared absorbers and inorganic infrared absorbers can be combined.

Examples of inorganic infrared absorbers include titanium oxide, zirconium oxide, tantalum oxide, niobium oxide, zinc oxide, tin oxide, indium oxide, indium tin oxide (ITO), antimony tin oxide (ATO), tungsten oxide, cesium oxide, cesium tungsten oxide (CWO), hexaborides such as, LaB₆, CeB₆, PrB₆, NdB₆, GdB₆, TbB₆, DyB₆, HoB₆, YB₆, SmB₆, EuB₆, ErB₆, TmB₆, YbB₆, LuB₆, SrB₆, CaB₆, and (La/Ce)B₆, and carbon black.

In one embodiment, the infrared absorber includes at least one selected from the group consisting of indium tin oxide (ITO), antimony tin oxide (ATO), cesium tungsten oxide (CWO), lanthanum boride (LaB₆), and carbon black.

In another embodiment, the infrared absorber includes at least one selected from the group consisting of cesium tungsten oxide and lanthanum boride. Cesium tungsten oxide and lanthanum boride are advantageously used because they absorb less visible light and selectively absorb light at near 800 to 1200 nm of wavelengths that take up much energy in sunlight.

The inorganic infrared absorber may be particulate. The average particle size of the inorganic infrared absorber is desirably about 1 nm or greater, or about 10 nm or greater, but about 0.5 μm or less, or about 0.1 μm or less. By using inorganic infrared absorbers having the average particle size within the range described above, the decrease in transparency with respect to visible light of the window film can be suppressed.

Examples of organic infrared absorbers include cyanine-based compounds; squarylium compounds; thiol nickel complex salt compounds;

phthalocyanine compounds; naphthalocyanine compounds; triallylmethane compounds; naphthoquinone compounds; anthraquinone compounds; amine compounds such as perchlorates of N,N,N′,N′-tetrakis(p-di-n-butylaminophenyl)-p-phenylenediaminium, chlorates of phenylene diaminium, hexafluoroantimonates of phenylene diaminium, boron fluorides of phenylene diaminium, fluoride salts of phenylene diaminium, and perchlorates of phenylene diaminium; phosphate ester cupper compounds obtained by the reaction of cupper compounds and bisthiourea compounds, phosphorus compounds and cupper compounds, and phosphate ester compounds and cupper compounds.

The infrared absorbing layer can be formed by applying an infrared absorbing coating agent including the infrared absorber and a binder or a curable composition onto the film layer 12 or another layer and heating or irradiating with radiation as necessary. The curable composition may be a hard coating composition or an anti-smudge coating composition. The film such as polyethylene terephthalate mixed with the infrared absorber may be laminated onto the film layer 12 or other layers. The lamination may be performed using an adhesive, heat fusing, or melt extrusion.

The thickness of the infrared absorber can be, for example, about 0.5 μm or greater, or about 1 μm or greater, but about 10 μm or less, or about 5 μm or less.

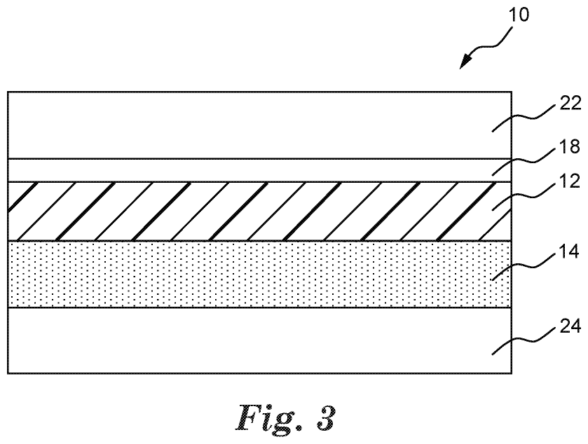

In one embodiment, the window film further includes an infrared reflective layer. The schematic cross-sectional view of the window film according to this embodiment is illustrated in FIG. 3. In the window film 10 in FIG. 3, the infrared reflective layer 18 is disposed on the surface of the film layer 12 opposite to the pressure sensitive adhesive layer 14. The infrared reflecting layer 18 may be disposed between the film layer 12 and the pressure sensitive adhesive layer 14, or may be disposed on another layer above the film layer 12, such as the hard coat layer, the anti-smudge coating layer, or the decorative layer.

The infrared reflecting layer may be a multilayer optical film (Multiple Optical Film, MOF) or a metal thin film.

Since the multilayer optical film has excellent wavelength selectivity, infrared light can be sufficiently shielded while high transmission of visible light is maintained. The multilayer optical film that functions as the infrared reflecting layer has, for example, more than 200 layers, and a thickness of the layer is designed so that each of the layers of the multilayer optical film reflects infrared light.

The multilayer optical film may be formed by a combination of alternating different polymeric layers. In one embodiment, at least one of the alternating polymer layers is oriented to be birefringent. In another embodiment, one of the alternating polymer layers is oriented to be birefringent and the other is isotropic.

In one embodiment, the multilayer optical film is formed by alternating a first polymeric layer and a second polymeric layer. Examples of the combination of the first polymer and the second polymer include a combination of polyethylene terephthalate (PET) or a copolymer of polyethylene terephthalate (coPET) and poly(methyl methacrylate) (PMMA) or a copolymer of poly(methyl methacrylate) (PMMA); a combination of polyethylene terephthalate and poly(methyl methacrylate-ethyl acrylate) copolymer; a combination of glycolated polyethylene terephthalate (PETG) (a copolymer of ethylene terephthalate and a second glycol, for example, cyclohexane dimethanol and terephthalic acid) or a copolymer of glycolated polyethylene terephthalate (coPETG) and polyethylene naphthalate (PEN) or a copolymer of polyethylene naphthalate (coPEN); and a combination of polyethylene naphthalate or a copolymer of polyethylene naphthalate and poly(methyl methacrylate) or a copolymer of poly(methyl methacrylate).

The optical layer thicknesses (numerical values obtained by multiplying the physical thickness by the refractive index) of each layer of the multilayer optical film are not particularly limited, but may be, for example, about 100 nm or greater, or about 200 nm or greater, but about 10 μm or less, or about 5 μm or less.

The multilayer optical film may have, for example, about 50 layers or more, or about 150 layers or more, or about 2000 layers or less, or about 1000 layers or less.

The thickness of the multilayer optical film can be, for example, about 5 μm or greater, about 10 μm or greater, or about 20 μm or greater, but about 1000 μm or less, about 500 μm or less, or about 300 μm or less.

As the multilayer optical film, those described in U.S. Pat. No. 3,610,724 (Rodgers), U.S. Pat. No. 3,711,176 (Alfrey Jr et. al.) “Highly Reflective Thermoplastic Optical Bodies For Infrared, Visible or Ultraviolet Light”, U.S. Pat. No. 4,446,305 (Rodgers et. al.), U.S. Pat. No. 4,540,623 (Imu et. al.), U.S. Pat. No. 5,448,404 (Shrenk et. al.), U.S. Pat. No. 5,882,774 (Johnza et. al.) “Optical Film”, U.S. Pat. No. 6,045,894 (Johnza et. al.) “Clear to Colored Security Film”, U.S. Pat. No. 6,531,230 (Waber et. al.) “Color Shifting Film”, WO 99/39224 (Auderkirk et. al.) “Infrared Interference Filter”, and U.S. Patent Application Publication No. 2001/0022982 (Neebin et. al.) “Apparatus For Making Multilayer Optical Films” can be used.

The multilayer optical film can be laminated to the film layer 12 or another layer using an adhesive.

A metal vapor deposition film or a metal alloy vapor deposition film such as aluminum, gold, silver, or copper can be used as the metal thin film that functions as the infrared reflecting layer. In one embodiment, the total light transmittance of infrared light in the metal thin film is about 70% or less, about 60% or less, or about 50% or less.

The metal vapor deposition film and the metal alloy vapor deposition film can be formed by, for example, depositing the metal or metal alloy on the film layer 12.

Although the thickness of the metal thin film can be, for example, about 5 μm or greater, or about 10 μm or greater, but about 1000 nm or less, or about 500 μm or less.

The total light transmittance of visible light in the metal thin film is desirably about 1% or greater, about 10% or greater, or about 20% or greater in order to ensure transparency of the window film to visible light.

The window film can be manufactured, for example, by the following method. The pressure sensitive adhesive composition in which the (meth)acrylic copolymer and optionally the crosslinking agent, the UV absorber, and the additive are dissolved or dispersed in a solvent if needed is applied on the film layer 12 surface-treated or provided with a primer layer if needed, and is optionally heated and/or irradiated with a radiation to form the pressure sensitive adhesive layer 14 on the film layer 12, thereby obtaining a window film. In another method, the pressure sensitive adhesive composition is applied onto the release liner 24 or another liner and, optionally, heated and/or irradiated to form the pressure sensitive adhesive layer 14. The window film can be obtained by transferring the resulting pressure sensitive adhesive layer 14 onto the film layer 12. The hard coat layer, the anti-smudge coating layer, the decorative layer, and/or the infrared absorbing layer may be previously formed on the film layer 12, and in this case, the pressure sensitive adhesive composition may be applied onto these layers to form the pressure sensitive adhesive layer 14. Alternatively, after producing the window film, the hard coat layer, the anti-smudge coating layer, the decorative layer, and/or the infrared absorbing layer may be formed on the film layer 12 side of the window film.

The thickness of the window film can be, for example, about 5 μm or greater, about 10 μm or greater, or about 12 μm or greater, but about 1000 μm or less, about 500 μm or less, or about 300 μm or less. The thickness of the window film does not include the thickness of the surface protective liner and the release liner.

In one embodiment, the total light transmittance of the visible light in the window film is about 30% or greater, about 40% or greater, or about 50% or greater, but 100% or less, about 90% or less, or about 80% or less. The window film having the total light transmittance of visible light in the range described above can ensure visibility through the window glass.

For window films used in automotive front windows and front door windows, the lower limit of the transmittance of visible light may be regulated by regulations so as not to impair the visibility of the driver from the perspective of safety. The total light transmittance of the visible light in the window film used for this application is regulated to be 70% or higher. In a case where the window glass includes a functional additive or the window glass has a large thickness, it is desirable for the total light transmittance of the visible light of the window film to be about 80% or greater.

In one embodiment, the total light transmittance of the ultraviolet light in the window film is less than about 1%, less than about 0.8%, or less than about 0.5%. The window film having the total light transmittance of ultraviolet light in the range described above can effectively inhibit the transmission of ultraviolet light into the vehicle or into the room. As a result, for example, in automotive applications, tanning of the passenger of the automobile can be prevented, and discoloration of the interior of the automobile can be suppressed.

In one embodiment, the total light transmittance of the infrared light in the window film is less than about 50%, less than about 40%, or less than about 30%. The window film having the total light transmittance of the infrared light in the range described above can effectively block heat rays that result in an increase in temperature within the vehicle or within the room.

In one embodiment, the maximum adhesive force of the window film is when the window film is cut into a width 25 mm and a length 250 mm, pressed against a glass plate using a 2 kg roller for one reciprocating pressing, maintained in an environment of 25° C., relative humidity of 50% for 24 hours, measured at a peeling speed of 300 mm/min, a peeling angle of 180° using a tensile tester, about 3N/25 mm or more, about 4 N/25 mm or greater, or about 5 N/25 mm or greater, but about 15 N/25 mm or less, about 12 N/25 mm or less, or about 10 N/25 mm or less. Due to the maximum adhesive force within the range described above, the window film can be adhered to the window glass with sufficient adhesive force to support the weight of the window film, and the window film can be removed cleanly without breaking the window film when the window film adhered to the window glass is re-adhered or removed.

In one embodiment, the adhesive force of the window film at 5 minutes after water bonding is at least about 15%, at least about 20%, or at least about 25% of the maximum adhesive force. In one embodiment, the adhesive force of the window film at 30 minutes after water bonding is at least about 20%, at least about 25%, or at least about 30% of the maximum adhesive force. In one embodiment, the adhesive force of the window film at 60 minutes after water bonding is at least about 30%, at least about 40%, or at least about 50% of the maximum adhesive force. The adhesive force at 5, 30, or 60 minutes after water bonding is measured by cutting the window film into a width 25 mm and a length 250 mm, pressing against a glass plate whose surface distilled water is applied to using a 2 kg roller for one reciprocating pressing, maintained in an environment of 25° C., relative humidity of 50% for 5, 30, or 60 minutes, and measuring with a tensile tester at a peeling speed of 300 mm/min, a peeling angle of 180°.

The window film may have a surface protective liner that protects the film layer 12 or the surface of the layer thereon. The window film may have a release liner that protects the surface of the pressure sensitive adhesive layer 14.

Examples of surface protective liners and release liners include films including paper such as kraft paper or polyolefins such as polyethylene and polypropylene; ethylene vinyl acetate; polyurethane; polyesters such as polyethylene terephthalate. The surface protective liner and release liner may optionally be coated with a silicone-containing material or a fluorocarbon-containing material. The thickness of the surface protective liner and release liner can be generally about 5 μm or greater, about 15 μm or greater, or about 25 μm or greater, but about 300 μm or less, about 200 μm or less, or about 150 μm or less.

The window film may be attached to only the outer surface of the window glass, may be attached to only the inner surface of the window glass, or may be attached to both the outer surface and the inner surface of the window glass. For example, in automotive applications, the window film can be applied to either or more of a front window, a front and rear door window, a side window, and a rear window.

The window film can be configured to be applied to a vehicle, for example, an automobile, a railroad vehicle, a ship, or the like.

The window film of the present disclosure can be suitably applied to the window glass by the water bonding method. The window film of the present disclosure can also be applied to the window glass in a manner other than the water bonding method.

As an example of the water bonding method, a procedure for applying a window film to an inside surface of a rear window of an automobile is described.

A construction liquid is prepared. As the construction liquid, a surfactant dissolved in distilled water, ion exchanged water, or tap water can be used. The surfactant contributes to improving the wettability of the construction liquid to the surface of the window glass, adjusting the evaporation time, and the like. As nonionic surfactants, ester types such as glycerine fatty acid esters, sorbitan fatty acid esters, and sucrose fatty acid esters; ether types such as alkyl polyethylene glycols, and polyoxyethylene alkylphenyl ethers; and nonionic surfactants such as alkylglycosides can be used. The concentration of the surfactant in the construction liquid can be, for example, about 0.01 mass % or greater, about 0.1 mass % or greater, or about 0.2 mass % or greater, but about 5 mass % or less, about 4 mass % or less, or about 3 mass % or less.

The size of the rear window is measured and the window film with the surface protective liner and the release liner is cut to be larger than the size of the rear window. The outer surface of the rear window (opposite to the plane to which the window film is applied) is cleaned and the construction liquid is sprayed onto the outer surface of the rear window. The window film is applied to the outer surface of the rear window such that the release liner of the window film is exposed, i.e., the surface protective liner of the window film contacts the outer surface of the rear window. At this time, the window film adsorbs to the outer surface of the rear window by the surface tension of the construction liquid. The window film is aligned and is cut slightly larger along the perimeter of the rear window. The hot air is applied to the portion where the window film is not in contact with the rear window, in particular the curved portion of the rear window, using a heat gun or the like to shrink that portion of the window film, thereby causing the portion to contact the surface of the rear window. Again, the construction liquid is sprayed between the window film and the rear window, and the window film is brought into close contact with the outer surface of the rear window using a squeegee. Hot air is again applied to the poorly adhered portion of the window film using a heat gun or the like to shrink the window film. After marking the outline of the inside surface of the rear window on the window film with the window film adhered to the outer surface of the rear window, and then removing the window film from the outer surface of the rear window, the window film is cut out precisely to be matched with the outline of the inside surface of the rear window.

The inside surface of the rear window is cleaned and the construction liquid is sprayed onto the inside surface of the rear window. The release liner of the window film is removed, and the construction liquid is also sprayed on the surface of the pressure sensitive adhesive layer of the window film. The window film is applied to the inside surface of the rear window. The surface protective liner of the window film is removed, and the construction liquid is sprayed on the surface of the window film as well. Using a squeegee, the window film is pressed against the inside surface of the rear window while scraping the construction liquid between the window film and the inside surface of the rear window toward the outer perimeter of the window film, and the window film is adhered to the inside surface of the rear window.

The window film of the present disclosure can be suitably used in window glasses such as automobiles, buildings, and the like. The window film of the present disclosure can also be used in other applications other than window glass of automobiles, buildings, and the like.

### EXAMPLES

Although specific embodiments of the present disclosure will be exemplified in the following examples, the present invention is not limited to these examples. All parts and percents are based on the mass, unless otherwise stated.

### Example 1

A (meth)acrylic copolymer was synthesized by a conventional solution polymerization method. A monomer mixture was prepared by mixing 100 parts by mass of ethyl acetate, 55 parts by mass of 2-ethylhexyl acrylate (2EHA), 40 parts by mass of 2-ethylhexyl methacrylate (2EHMA), 2 parts by mass of 2-hydroxypropyl acrylate (HPA), and 3 parts by mass of 2-hydroxypropyl methacrylate (HPMA). To the mixture was added 0.2 parts by mass of 2,2′-azobis (2,4-dimethylvaleronitrile) (V-65, manufactured by FUJIFILM Wako Pure Chemical Corporation, Osaka-shi, Osaka, Japan) as an initiator. The mixture was caused to react at 50° C. for 24 hours in a nitrogen atmosphere to obtain 50% solution of (meth)acrylic copolymer in ethyl acetate.

To 100 parts by mass of the resulting (meth)acrylic copolymer solution were mixed 3.13 parts by mass of Tinuvin (trade name) 477 (80% solution of hydroxyphenyl triazine derivative in butyl acetate, BASF, Ludwigshafen am Rhein, Land Rheinland-Pfalz, Germany) and 0.19 parts by mass of Coronate (trade name) 2203 (90% solution of hexamethylene diisocyanate derivative in ethyl acetate, Tosoh Corporation, Minato-ku, Tokyo) was mixed as a UV absorber (UVA).

The mixed solution was applied to a Y9SM6-1 (black polyester film having a thickness of 25 Rengo Co., Ltd., Osaka-shi, Osaka, Japan) so that the thickness after drying of the pressure sensitive adhesive layer is 20 μm, and dried at 90° C. for 5 minutes. A release treated polyester film (Purex (trademark) A-31, TEIJIN FILM SOLUTIONS LIMITED, Chiyoda-ku, Tokyo, Japan) having 38 μm of thickness was laminated as the release liner to obtain a window film.

### Example 2

Similar to Example 1, a monomer mixture was prepared by mixing 60.8 parts by mass of 2EHA, 34.3 parts by mass of n-butyl acrylate (BA), 2.9 parts by mass of acrylamide (AcM), 2.0 parts by mass of 2-hydroxyethyl acrylate (HEA), and 185.7 parts by mass of ethyl acetate. To the mixture was added 0.2 parts by mass of V-65 as the initiator. The mixture was caused to react at 50° C. for 24 hours in a nitrogen atmosphere to obtain 35% solution of (meth)acrylic copolymer in ethyl acetate.

To 100 parts by mass of the resulting (meth)acrylic copolymer solution were mixed 2.19 parts by mass of Tinuvin (trade name) 477, 0.08 parts by mass of Coronate (trade name) 2203. The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Example 3

Similar to Example 2, a monomer mixture of 83.3 parts by mass of 2EHA, 14.7 parts by mass of N-vinylpyrrolidone (NVP), and 2.0 parts by mass of HEA was used to obtain 35% solution of (meth)acrylic copolymer in ethyl acetate.

Similarly, 2.19 parts by mass of Tinuvin (trade name) 477, and 0.08 parts by mass of Coronate (trade name) 2203 were mixed into 100 parts by mass of the resulting solution of the (meth)acrylic copolymer. To Y9SM6-1, the pressure sensitive adhesive layer was applied so that the thickness after drying of the pressure sensitive adhesive layer is 20 μm, dried at 90° C. for 5 minutes, and Purex (trade name) A-31 was laminated to obtain a window film.

### Example 4

Similar to Example 3, a monomer mixture of 83.3 parts by mass of 2EHA, 14.7 parts by mass of N-vinylpyrrolidone (NVP), and 2.0 parts by mass of acrylic acid (AA) was used to obtain 35% solution of (meth)acrylic copolymer in ethyl acetate.

Similarly, to 100 parts by mass of the resulting (meth)acrylic copolymer solution were mixed 2.19 parts by mass of Tinuvin (trademark) 477, and 1.4 parts by mass of E-AX (5% solution of epoxy crosslinking agent in toluene, Soken Chemical & Engineering Co., Ltd.). The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Example 5

Similar to Example 4, a monomer mixture of 83.3 parts by mass of 2EHA, 14.7 parts by mass of N,N-dimethyl acrylamide (DMAA), and 2.0 parts by mass of HEA was used to obtain 35% solution of (meth)acrylic copolymer in ethyl acetate.

Similarly, to 100 parts by mass of the resulting (meth)acrylic copolymer solution were mixed 2.19 parts by mass of Tinuvin (trade name) 477, and 1.4 parts by mass of E-AX. The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Example 6

Similar to Example 2, a monomer mixture of 83.3 parts by mass of 2EHA, 14.7 parts by mass of DMAA, and 2.0 parts by mass of HEA was used to obtain 35% solution of (meth)acrylic copolymer in ethyl acetate.

Similarly, to 100 parts by mass of the resulting (meth)acrylic copolymer solution were mixed 2.19 parts by mass of Tinuvin (trade name) 477, and 0.08 parts by mass of Coronate (trade name) 2203. The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Example 7

An ultraviolet light curable hard coat composition PIS-3 YB (acrylic precursor containing an infrared absorber, Mitsubishi Materials Electronic Chemicals Co., Ltd., Akita-shi, Akita, Japan) was applied by gravure coating on a polyester film having a thickness of 25 μm (DIAFOIL (trade name) T600E-25N, Mitsubishi Chemical Corporation, Chiyoda-ku, Tokyo, Japan), dried at 65° C. for 3 minutes, irradiated with 700 mJ/cm² ultraviolet light (UV-A) using a UV (ultraviolet) curing non-electrode UV lamp (DRS model) H valve (Heraeus Holding, Bunkyo-ku, Tokyo, Japan), and then an infrared absorbing hard coat layer having a thickness of 2 μm was provided.

The pressure-sensitive adhesive composition used in Example 6 was applied on the side opposite to the hard coat layer so that the thickness after drying of the pressure sensitive adhesive layer was 20 μm, and dried at 90° C. for 5 minutes. Purex (trade name) A-31 was laminated to obtain a window film.

### Comparative Example 1

Similar to Example 2, a monomer mixture of 77 parts by mass of methyl acrylate (MA), 15 parts by mass of acryloyl morpholine (ACMO), and 3 parts by mass of HEA was used to obtain 35% solution of (meth)acrylic copolymer in ethyl acetate.

To 100 parts by mass of the resulting (meth)acrylic copolymer solution were mixed 2.19 parts by mass of Tinuvin (trademark) 477, and 0.08 parts by mass of Coronate (trade name) 2203. The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Comparative Example 2

Similar to Example 4, a monomer mixture of 72 parts by mass of BA, 10 parts by mass of MA, 15 parts by mass of DMAA, 2.5 parts by mass of AA, and 0.5 parts by mass of HEA was used to obtain 35% solution of (meth)acrylic copolymer in ethyl acetate.

To 100 parts by mass of the resulting (meth)acrylic copolymer solution were mixed 2.19 parts by mass of Tinuvin (trade name) 477, and 1.4 parts by mass of E-AX. The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Comparative Example 3

Similar to Example 3, a monomer mixture of 72 parts by mass of BA, 15 parts by mass of MA, 10 parts by mass of DMAA, and 3 parts by mass of HEA was used to obtain 35% solution of (meth)acrylic copolymer in ethyl acetate.

To 100 parts by mass of the resulting (meth)acrylic copolymer solution were mixed 2.19 parts by mass of Tinuvin (trade name) 477, and 0.08 parts by mass of Coronate (trade name) 2203. The mixture was applied to a Y9SM6-1 so that the thickness after drying of the pressure sensitive adhesive layer is 20 μm, and dried at 90° C. for 5 minutes. Purex (trade name) A-31 was laminated to obtain a window film.

### Sample Evaluation Method

### (1) Solubility Parameter of (Meth)Acrylic Copolymer (SP Value)

The SP value of the (meth)acrylic copolymer was calculated by using Fedors' method (R. F. Fedors, “A Method for Estimating Both the Solubility Parameters and Molar Volumes of Liquids”, Polym. Eng. Sci., 14(2), pp. 147-154, 1974). The SP value (δ) (in units (MPa)^{1/2}) is defined as the square root of the cohesive energy density as shown below: Where V is molecular weight, ΔEv is cohesive energy (evaporation energy).

SP value (δ)=(ΔEv/V)^{1/2}

### (2) Transmittance

After removing the release liner, the total light transmittance of visible light (from 380 to 780 nm), solar light transmittance (from 300 to 2500 nm), the total light transmittance of ultraviolet (UV) (from 300 to 380 nm), and the total light transmittance of infrared (IR) (from 780 to 2500 nm) were measured by a Spectrophotometer U-4100 (Hitachi High-Technologies Corporation, Minato-ku, Tokyo, Japan) in accordance with JIS A 5759 (2008). Light was incident from the side of the pressure sensitive adhesive layer.

The infrared and ultraviolet light-shielding window film desirably exhibit the total light transmittance of the infrared light of less than 50% (in other words, the infrared shield of 50% or greater), and the total light transmittance of the ultraviolet light of less than 1.0%. The total light transmittance of visible light is determined depending on the application.

### (3) Haze (Turbidity)

On a glass was dropped 2 mL of distilled water. The pressure sensitive adhesive layer of the sample of the window film was brought into contact with the glass to cover the distilled water with the sample, and pressed a 2 kg roller in order to escape the water droplets between the pressure sensitive adhesive layer and the glass surface. The overflow water was wiped and the haze was measured after 5 minutes and 60 minutes. A haze meter NDH-5000 W (Nippon Denshoku Industries Co., Ltd., Bunkyo-ku, Tokyo, Japan) was used for the measurement.

If water is not removed from between the film and glass with a roller of 2 kg, the remaining water penetrates into the pressure sensitive adhesive layer, causing the pressure sensitive adhesive layer to become cloudy and the haze value increases.

### (4) Water Bonding Adhesion to Glass

A sufficient distilled water was sprayed on a glass. The pressure sensitive adhesive layer of the sample of the window film was brought into contact with the glass to cover the distilled water with the sample, and pressed a 2 kg roller in order to escape the water droplets between the pressure sensitive adhesive layer and the glass surface. The overflow water was wiped off. In an environment of relative humidity of 50%, a peeling test was performed after 5 min, 30 min, 60 min and after 24 hours using a tensile tester at a peeling speed of 300 mm/min and a peeling angle of 180°.

The rate of increase in adhesion (adhesion build-up ratio) was defined by the following equation: The adhesive force after 24 hours was considered as the maximum adhesive force (100%).

Percent increase in adhesive force (%)=adhesive force at every elapsed time (N/25 mm)/adhesive force after 24 hours (N/25 mm)

The adhesive force is increased with water evaporation. Immediately after water bonding, the window film is adhered on the glass by cohesive force due to the surface tension of the water. Thereafter, the water present between the pressure sensitive adhesive layer and the glass is gradually dissipated from the film edge and through the film to cause the film to adhere to the glass by the adhesive force of the pressure sensitive adhesive.

During water bonding, when the film is aligned, and the water between the pressure sensitive adhesive layer and the glass is pressed or scraped by a squeegee, the window film is locally extended and stress remains. Then, in a case where the force that the film attempts to return to its original shape exceeds the adhesive force of the pressure sensitive adhesive layer to the glass, peeling occurs from the end of the film. When water bonding, it was found that peeling from the edge of the film can be suppressed in cases where the adhesive force increase rate of 20% or more is exhibited in a short period of time, for example, about 5 minutes.

Table 1 shows the result.

In Example 1 to 7, the films of Example 1 to 7 are useful as the window film because a transmittance of ultraviolet light of less than 0.1% and infrared shield of 50% or greater were achieved and there was no haze change.

In Example 1 to 7, the adhesive force increase rate of 20% or more is obtained at 5 minutes after water bonding, and peeling of the film was suppressed. In Comparative Example 1 to 3, the adhesive force did not easily increase (recovery), and peeling from the edge occurred over time.

TABLE 1
TABLE 1-1

| | | Example 1 | Example 2 | Example 3 | Example 4 | Example 5 |
|---|---|---|---|---|---|---|
| (Meth)acrylic copolymer | | 2EHA/2EHMA/ | 2EHA/BA/ | 2EHA/NVP/ | 2EHA/NVP/ | 2EHA/DMAA/ |
| | | HPA/HPMA | AcM/HEA | HEA | AA | AA |
| | | (55/40/2/3) | (60.8/34.3/2.9/2.0) | (83.3/14.7/2.0) | (83.3/14.7/2.0) | (83.3/14.7/2.0) |
| SP value ((MPa)^{1/2}) | | 18.95 | 19.57 | 19.93 | 19.92 | 19.72 |
| Total light transmittance (%) of | | 34.8 | 36.1 | 36.2 | 34.8 | 34.9 |
| visible light (from 380 to 780 nm) | | | | | | |
| Solar light transmittance (%) | | 47.8 | 49.6 | 49.5 | 48.5 | 48.3 |
| (from 300 to 2500 nm) | | | | | | |
| Total light transmittance (%) of | | 0.0 | 0.0 | 0.0 | 0.0 | 0.0 |
| ultraviolet light (from 300 to 380 nm) | | | | | | |
| Infrared shield (%) | | 57.4 | 55.4 | 56.1 | 55.5 | 56.0 |
| (from 780 to 2500 nm) | | | | | | |
| Haze after 5 minutes (%) | | 1.14 | 1.38 | 1.08 | 1.07 | 1.17 |
| Haze after 60 minutes (%) | | 1.10 | 1.29 | 1.33 | 1.11 | 1.15 |
| Water bonding | 5 min | 1.73 (49%) | 0.96 (29%) | 2.60 (38%) | 2.76 (30%) | 2.08 (29%) |
| adhesive force (N/25 mm) | 30 min | 2.97 (84%) | 2.64 (79%) | 3.25 (48%) | 3.78 (40%) | 1.90 (26%) |
| (increase % in adhesive force) | 60 min | 3.07 (87%) | 2.94 (88%) | 4.71 (70%) | 7.38 (79%) | 4.08 (56%) |
| | 24 hours | 3.52 (100%) | 3.35 (100%) | 6.76 (100%) | 9.34 (100%) | 7.24 (100) |

TABLE 1-2
(Continued in Table 1)

| | | | | Comparative | Comparative | Comparative |
|---|---|---|---|---|---|---|
| | | Example 6 | Example 7 | Example 1 | Example 2 | Example 3 |
| (Meth)acrylic copolymer | | 2EHA/DMAA/ | 2EHA/DMAA/ | BA/MA/ | BA/MA/DMAA/ | BA/MA/ |
| | | HEA | HEA | ACMO/HEA | AA/HEA | DMAA/HEA |
| | | (83.3/14.7/2.0) | (83.3/14.7/2.0) | (77/5/15/3) | (72/10/15/2.5/0.5) | (72/15/10/3) |
| SP value ((MPa)^{1/2}) | | 19.73 | 19.73 | 21.09 | 21.25 | 21.31 |
| Total light transmittance (%) of | | 36.0 | 89.0 | 36.5 | 35.3 | 34.9 |
| visible light (from 380 to 780 nm) | | | | | | |
| Solar light transmittance (%) | | 49.4 | 71.7 | 49.7 | 48.2 | 47.7 |
| (from 300 to 2500 nm) | | | | | | |
| Total light transmittance (%) of | | 0.0 | 0.0 | 0.0 | 0.0 | 0.0 |
| ultraviolet light (from 300 to 380 nm) | | | | | | |
| Infrared shield (%) | | 55.6 | 71.4 | 55.4 | 56.9 | 58.0 |
| (from 780 to 2500 nm) | | | | | | |
| Haze after 5 minutes (%) | | 1.10 | 0.20 | 1.16 | 1.04 | 1.14 |
| Haze after 60 minutes (%) | | 1.04 | 0.20 | 1.04 | 1.14 | 1.01 |
| Water bonding | 5 min | 3.06 (47%) | 2.14 (28%) | 0.27 (4%) | 0.94 (10%) | 0.09 (4%) |
| adhesive force (N/25 mm) | 30 min | 5.25 (81%) | 5.38 (71%) | 1.10 (15%) | 0.95 (11%) | 0.27 (11%) |
| (increase % in adhesive force) | 60 min | 3.76 (58%) | 6.33 (83%) | 0.84 (12%) | 2.40 (27%) | 0.58 (23%) |
| | 24 hours | 6.50 (100%) | 7.59 (100%) | 7.17 (100%) | 9.00 (100%) | 2.56 (100%) |

1. A window film comprising a film layer and a pressure sensitive adhesive layer including a (meth)acrylic copolymer, wherein an SP value of the (meth)acrylic copolymer is less than 20 (MPa)^{1/2}.

2. The window film according to claim 1, wherein the (meth)acrylic copolymer includes from 40 parts by mass to 99.5 parts by mass of a unit derived from an alkyl (meth)acrylate having an alkyl group having from 6 to 20 carbon atoms based on 100 parts by mass of the (meth)acrylic copolymer.

3. The window film according to claim 1, wherein the (meth)acrylic copolymer comprises a unit derived from a nitrogen-containing ethylenically-unsaturated monomer.

4. The window film according to claim 1, wherein the (meth)acrylic copolymer is free of units derived from (meth)acrylic acid.

5. The window film according to claim 1, wherein the pressure sensitive adhesive layer comprises a UV absorber.

6. The window film of claim 5, wherein the UV absorber comprises a triazine-based UV absorber.

7. The window film according to claim 1, further comprising an infrared absorbing layer comprising an infrared absorber.

8. The window film according to claim 1, wherein the film layer comprises an infrared absorber.

9. The window film according to claim 7, wherein the infrared absorber comprises at least one selected from the group consisting of indium tin oxide, antimony tin oxide, cesium tungsten oxide, lanthanum boride and carbon black.

10. The window film according to claim 1, further comprising an infrared reflective layer.

11. The window film of claim 10, wherein the infrared reflecting layer is a multilayer optical film or a metal thin film.

12. The window film according to claim 1, wherein the total light transmittance in the range of 380 nm to 780 nm of wavelength is 30% or greater.

13. The window film according to claim 1, wherein the total light transmittance in the range from 300 nm to 780 nm of wavelength is less than 1%.

14. The window film according to claim 1, wherein the total light transmittance in the range from 780 nm to 2500 nm of wavelength is less than 50%.

15. The window film according to claim 1, wherein the window film is applied to a window glass by a water bonding method.

16. The window film according to claim 1, wherein the window film is configured to be applied to a vehicle.

17. The window film according to claim 1, wherein the film layer is a polyethylene terephthalate film.
